(19) United States
(12) Patent Application Publication
(10) Pub. No.: US 2019/0285517 A1
(43) Pub. Date: Sep. 19, 2019

(54) METHOD FOR EVALUATING HEALTH STATUS OF MECHANICAL EQUIPMENT

(71) Applicants: NANJING UNIV. OF AERONAUTICS AND ASTRONAUTICS, Jiangsu (CN); MIRACLE AUTOMATION ENGINEERING CORP. LTD., Jiangsu (CN)

(72) Inventors: Peihuang LOU, Jiangsu (CN); Dahong GUO, Jiangsu (CN); Xiaoming QIAN, Jiangsu (CN); Jiong ZHANG, Jiangsu (CN)

(21) Appl. No.: 16/461,738

(22) PCT Filed: Jan. 4, 2018
(86) PCT No.: PCT/CN2018/071230

§ 371 Date: May 16, 2019

(30) Foreign Application Priority Data
Oct. 25, 2017 (CN) 201711007920.6

(51) Int. Cl. G01M 99/00; G06N 3/04; G06N 3/08

(52) U.S. Cl. CPC G01M 99/005; G06N 3/08; G06N 3/0454

(57) ABSTRACT

Disclosed is a method for evaluating a health status of mechanical equipment. Firstly, status data of main components on mechanical equipment are collected by a sensor, and feature extraction is performed to obtain feature parameters. Then, noise data and fault data are extracted by an outlier detection algorithm, and only the fault data are retained. Subsequently, dimension reduction processing is performed to obtain a feature vector for final evaluation. Finally, equipment status evaluation is performed, a self-organizing map neural network model is established by health status data and failure status data, rate impact factors of each group of data to be evaluated are calculated by an entropy weight theory, and the rate impact factors are introduced into a neural network to perform health factor calculation. The present invention implements overall status evaluation for mechanical equipment, provides a basis for health maintenance of the mechanical equipment, and avoids unnecessary economic losses.

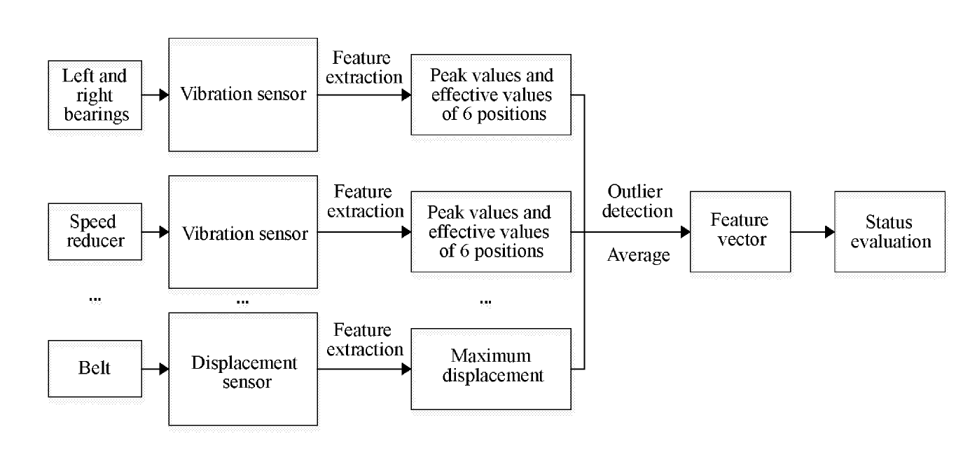

### FIELD OF THE INVENTION

The present invention belongs to the field of intelligent system technology applications, and in particular, to a method for evaluating a health status of mechanical equipment.

### DESCRIPTION OF RELATED ART

At present, intelligent manufacturing has become a research hot-spot in modern manufacturing. Production equipment is developing in the direction of intelligence. The production process of a workshop is highly complex and time-varying. In the current diagnosis of equipment state mainly relies on manual on-site analysis, and fault diagnosis is completed through expert experience. However, this diagnosis has the following problems:

(1) It is difficult to form a general system diagnostic model.

(2) Operational data is not fully utilized.

(3) It can only guarantee that equipment continues to operate, but how long it can work normally is unpredictable, and it is impossible to predict the status of the equipment in the early stage of a fault.

In this regard, it is urgent to establish an automated intelligent equipment diagnostic analysis platform. Through intelligent diagnostic analysis, equipment maintenance personnel can predict the health status and fault occurrence of equipment in advance, thereby improving the production efficiency of a workshop, reducing the production cost and avoiding the occurrence of major production accidents. Mechanical production equipment is usually composed of many complex components. Failure of one component may lead to the fault of the entire equipment, and high failure rate of the mechanical production equipment may cause huge economic losses and casualties. Therefore, it is necessary to monitor the real-time status of the equipment. Nowadays, with the development of sensors and information technology, the intelligent level of mechanical equipment is constantly increasing, which helps to obtain more information for equipment status evaluation. The literature “Initial Fault Detection and Status Monitoring of Rolling Bearing Based on Mahalanobis-Taguchi System [Master's thesis], Lanzhou, Lanzhou University of Technology, 2016” analyzed the fault diagnosis technology of bearings. For the mechanical production equipment, the fault diagnosis technology may detect fault types and fault sources. However, the global status or performance of the equipment cannot be evaluated. In order to improve safety and reliability, status evaluation is crucial. It not only reflects the global degree of degradation of the equipment which can provide a reference for an enterprise, but also provides a necessary basis for the next prediction and health management.

However, the existing status evaluation studies have focused on parts or component units, such as bearings and some electronic systems, and the global evaluation of a health status of mechanical equipment is not adequately studied. In view of the complexity of the mechanical equipment, the health status of the equipment needs to be reflected based on parts and components. Since each component is of different importance in a equipment, status features collected from sensors should be endowed with different weights. However, the current study on status evaluation lacks a method of weighted decision making. A common method is to give weights based on experience, but these weights do not reflect the change rate of attribute data.

### SUMMARY OF THE INVENTION

### Technical Problem

In order to solve the technical problems in DESCRIPTION OF RELATED ART, the present invention is intended to provide a method for evaluating a health status of mechanical equipment, which overcomes the defects of the existing status diagnosis technology, and implements the global evaluation of mechanical equipment.

### Technical Solution

In order to achieve the above technical purpose, the technical solution of the present invention is as follows:

A method for evaluating a health status of mechanical equipment includes the following steps:

(1) collecting status data from main components of the mechanical equipment by using a sensor;
(2) performing feature extraction on the status data of different components by using different feature extraction methods to obtain feature parameters, and classifying the feature parameters of each component into a group to obtain a feature parameter set of each component;
(3) performing outlier detection on the feature parameter set of each component by an outlier detection algorithm to obtain noise data and fault data, retaining the fault data reflecting an equipment health status, and removing the noise data;
(4) performing feature dimension reduction on the fault data of each denoised component, and combining a feature vector;
(5) repeating steps (1) to (4) for many times to obtain a plurality of feature vectors;
(6) training a self-organizing map neural network model by preset health status data and failure status data to obtain a trained network model; and
(7) calculating a rate impact factor of each feature vector obtained in step (5) according to an information entropy theory, introducing the rate impact factor into a self-organizing map neural network, and calculating a health factor, such that the health factor can not only reflect a degree of distance from a current status to a health status, but also reflect the influence of a data change rate on the health status.

Further, step (3) has the following specific processes:

for a certain feature point p in a feature parameter set D, denoting a k distance of the feature point as distₖ(p), which represents a distance between p and another feature point o_{∈}D, and satisfies at least k feature points o′_{∈}D−p, such that d(p,o′)≤d(p,o), where d(p,o) represents a Euclidean distance of two feature points, and satisfies at least k−1 feature points o″_{∈}D−p, so d(p,o″)<d(p,o); and denoting a k distance neighborhood of p as N(k)(p), which contains all feature points, the distance from the feature points to p is not greater than distₖ(p), that is, N₍ₖ₎(p)={q★D−p|d(p,q)≤distₖ(p)};
calculating a local outlier point factor LOFₖ(p) of p:

$${LOF}_{k} ( p ) = \frac{{\sum }_{o ∈ {N}_{k} ( p )} \begin{matrix}{lrd}_{k} ( o ) \\ {lrd}_{k} ( p )\end{matrix}}{\vert {N}_{k} ( p ) \vert}$$

where |Nₖ(p)| is the number of elements of N₍ₖ₎(p), lrdₖ(o) and lrdₖ(p) are local reachable densities of feature points o and p, respectively,

$${lrd}_{k} ( p ) = \frac{\vert {N}_{k} ( p ) \vert}{{\sum }_{o ∈ {N}_{k} ( p )} {reachdis}_{k} ( o ← p )} , \\ {lrd}_{k} ( o ) = \frac{\vert {N}_{k} ( o ) \vert}{{\sum }_{p ∈ {N}_{k} ( p )} {reachdis}_{k} ( p ← o )} ,$$

reachdistₖ(p←o)=max{distₖ(o),d(p,o)} represents a reachable distance from the feature point o to the feature point p, and reachdistₖ(o←p)=max{distₖ(p),d(p,o)} represents a reachable distance from the feature point p to the feature point o; and
setting thresholds LOF1 and LOF2, where when LOFₖ(p) is greater than LOF1, the feature point is fault data, and when LOFₖ(p) is greater than LOF2 and less than LOF1, the feature point is noise data.

Further, step (6) has the following specific processes:

setting wᵢ=[wᵢ₁, wᵢ₂, . . . , wᵢₙ] as a weight of an i^{th} neuron of the self-organizing map neural network, setting W=[W₁, W₂, . . . , Wₙ] as a subjective weight of a component, and setting n as a number of dimensions of an input feature vector, as follows:
(a) initializing a network weight;
(b) inputting a feature vector of health status data and a feature vector of failure status data respectively;
(c) calculating a distance between a weight vector of a map layer and the input feature vectors:

$${d}_{j} = \sqrt{{\sum }_{i = 1}^{m} {[ {x}_{i} ( t ) - {w}_{ij} ( t ) ]}^{2}} ,$$

where m is the number of neurons, xᵢ represents an i^{th} input feature vector, t represents a time, and j=1, 2, . . . , n;
(d) obtaining a neuron corresponding to a minimum distance value d and a neighborhood thereof;
(e) correcting the weight vector:

Δwᵢⱼ=wᵢⱼ(t+1)−wᵢⱼ(t)=η(t)h_{i,j}(t)[xᵢ(t)−wᵢⱼ(t)],

where

$$η ( t ) = 0.2 ( 1 - \frac{t}{10000} ) , {h}_{i , j} ( t ) = exp ( - \frac{{d}_{ij}^{2}}{2 {σ}^{2} ( t )} )$$

represents a Gaussian function, dᵢⱼ is a distance between neurons i and j, and σ(t) is a neighborhood radius; and
(f) repeating steps (b) to (e) until the end of the training, so as to obtain two neural network models corresponding to the health status data and the failure status data.

Further, a calculation formula for the rate impact factor in step (7) is as follows:

$${E}_{j} = - {( ln m )}^{1} {\sum }_{i = 1}^{m} {P}_{ij} ln {P}_{ij} , j = , 1 , 2 , … , n$$

$${f}_{j} = 2 - {E}_{j} , j = 1 , 2 , … , n ,$$

where fⱼ is an image rate factor,

$${P}_{ij} = \frac{{x}_{ij}}{{\sum }_{i = 1}^{m} {x}_{ij}} ,$$

and xᵢⱼ is a j^{th} element of the i^{th} feature vector in step (5); and
a calculation formula for the health factor is as follows:

$${o}_{r} = F ( min ‖ f W x - {w}_{i} ‖ )$$

$$HI = \frac{{o}_{1}}{{o}_{1} + {o}_{2}} ,$$

where HI is a health factor, F(*) represents a function of *, f is a vector composed of n fⱼ, x is a certain feature vector in step (5), and subscript r takes 1 or 2, where o₁ is a distance from a feature vector to a health status, and o₂ is a distance from a feature vector to a failure status, which are respectively obtained from a neuron weight wᵢ in two neural network models corresponding to the health status data and the failure status data.

Further, the number of dimensions of the feature vector obtained in step (4) is not greater than 10.

### Advantageous Effect

The advantageous effects brought by the above technical solutions are as follows:

In the present invention, a self-organizing map neural network model is established by health status data and failure status data, rate impact factors of each group of data to be evaluated are calculated by an entropy weight theory, and the rate impact factors are introduced into a neural network to perform health factor calculation. The obtained health factor can not only reflect a degree of distance from a current status to a health status, but also reflect the influence of a data change rate on the health status.

### BRIEF DESCRIPTION OF THE DRAWINGS

The sole FIGURE is a flowchart of an embodiment of the present invention.

### DETAILED DESCRIPTION OF THE INVENTION

The technical solutions of the present invention will be described in detail below with reference to the accompanying drawings.

In the present embodiment, a belt hoist used in the production of an automobile assembly line is taken as an example to illustrate a method for evaluating a health status of mechanical equipment based on an information entropy and a self-organizing map neural network of the present invention. As shown in the sole FIGURE, the method includes the following steps:

Step 1: Data collection: Collect status data from main components of the belt hoist by using a sensor, including vibration acceleration signals of two bearings and a speed reducer and the displacement of a belt.
Step 2: Feature parameter extraction: Perform feature extraction on different data by using different feature extraction technologies to obtain feature parameters, namely effective values and peak values of the vibration acceleration signals of the two bearings and the speed reducer at six different positions during one operation of the hoist, and a maximum value of displacement.
Step 3: Outlier detection: Perform outlier detection on a feature parameter set of each component by a density-based outlier detection algorithm to obtain noise data and fault data, where since the fault data can reflect an equipment health status and the noise data are error data, the fault data need to be retained, and the noise data are removed.
Step 4: Data dimension reduction: Average the de-vibration effective values and peak values, and then combine them into a feature vector, such that the dimension of the feature vector is 7; and repeat the above steps to obtain a plurality of feature vector, the dimension of the feature vector is 7.
Step 5: Building of self-organizing map neural network model: Train a self-organizing map neural network model by the health status data and the failure status data to obtain a trained network model.
Step 6: Health factor calculation: Calculate a rate impact factor of each feature vector by an information entropy theory, introduce the rate impact factor into a self-organizing map neural network, and calculate a health factor, such that the health factor can not only reflect a degree of distance from a current status to a health status, but also reflect the influence of a data change rate on the health status.

The embodiments are only for explaining the technical idea of the present invention, and the scope of protection of the present invention is not limited thereto. Any changes made based on the technical solutions and according to the technical idea of the present invention fall within the scope of protection of the present invention.

1. A method for evaluating a health status of mechanical equipment, comprising the following steps:
(1) collecting status data from main components of the mechanical equipment by using a sensor;
(2) performing feature extraction on the status data of different components by using different feature extraction methods to obtain feature parameters, and classifying the feature parameters of each component into a group to obtain a feature parameter set of each component;
(3) performing outlier detection on the feature parameter set of each component by an outlier detection algorithm to obtain noise data and fault data, retaining the fault data reflecting an equipment health status, and removing the noise data;
(4) performing feature dimension reduction on the fault data of each denoised component, and combining a feature vector;
(5) repeating steps (1) to (4) for many times to obtain a plurality of feature vectors;
(6) training a self-organizing map neural network model by preset health status data and failure status data to obtain a trained network model; and
(7) calculating a rate impact factor of each feature vector obtained in step (5) according to an information entropy theory, introducing the rate impact factor into a self-organizing map neural network, and calculating a health factor, such that the health factor can not only reflect a degree of distance from a current status to a health status, but also reflect the influence of a data change rate on the health status.

2. The method for evaluating a health status of mechanical equipment according to claim 1, wherein step (3) has the following specific processes:
for a certain feature point p in a feature parameter set D, denoting a k distance of the feature point as distₖ(p), which represents a distance between p and another feature point o_{∈}D, and satisfies at least k feature points o′_{∈}D−p, such that d(p,o′)≤d(p,o), wherein d(p,o) represents a Euclidean distance of two feature points, and satisfies at least k−1 feature points o″_{∈}D−p, so d(p,o″)<d(p,o); and denoting a k distance neighborhood of p as N₍ₖ₎(p), which contains all feature points, the distance from the feature points to p is not greater than distₖ(p), that is, N₍ₖ₎(p)={q∈D−p|d(p,q)≤distₖ(p)};
calculating a local outlier point factor LOFₖ(p) of p:
$${LOF}_{k} ( p ) = \frac{{\sum }_{o ∈ {N}_{k} ( p )} \begin{matrix}{lrd}_{k} ( o ) \\ {lrd}_{k} ( p )\end{matrix}}{\vert {N}_{k} ( p ) \vert} ,$$
wherein |Nₖ(p)| is the number of elements of N₍ₖ₎(p), lrdₖ(o) and lrdₖ(p) are local reachable densities of feature points o and p, respectively,
$${lrd}_{k} ( p ) = \frac{\vert {N}_{k} ( p ) \vert}{{\sum }_{o ∈ {N}_{k} ( p )} {reachdis}_{k} ( o ← p )} , \\ {lrd}_{k} ( o ) = \frac{\vert {N}_{k} ( o ) \vert}{{\sum }_{p ∈ {N}_{k} ( p )} {reachdis}_{k} ( p ← o )} ,$$
reachdistₖ(p←o)=max{distₖ(o),d(p,o)} represents a reachable distance from the feature point o to the feature point p, and reachdistₖ(o←p)=max{distₖ(p),d(p,o)} represents a reachable distance from the feature point p to the feature point o; and
setting thresholds LOF1 and LOF2, wherein when LOFₖ(p) is greater than LOF1, the feature point is fault data, and when LOFₖ(p) is greater than LOF2 and less than LOF1, the feature point is noise data.

3. The method for evaluating a health status of mechanical equipment according to claim 1, wherein step (6) has the following specific processes:
setting wᵢ=[wᵢ₁, wᵢ₂, . . . , wᵢₙ] as a weight of an i^{th} neuron of the self-organizing map neural network, setting W=[W₁, W₂, . . . , Wₙ] as a subjective weight of a component, and setting n as a number of dimensions of an input feature vector, as follows:
(a) initializing a network weight;
(b) inputting a feature vector of health status data and a feature vector of failure status data respectively;
(c) calculating a distance between a weight vector of a map layer and the input feature vectors:
$${d}_{j} = \sqrt{{\sum }_{i = 1}^{m} {[ {x}_{i} ( t ) - {w}_{ij} ( t ) ]}^{2}} ,$$
wherein m is the number of neurons, xᵢ represents an i^{th} input feature vector, t represents a time, and j=1, 2, . . . , n;
(d) obtaining a neuron corresponding to a minimum distance value dⱼ and a neighborhood thereof;
(e) correcting the weight vector:
Δwᵢⱼ=wᵢⱼ(t+1)−wᵢⱼ(t)=η(t)h_{i,j}(t)[xᵢ(t)−wᵢⱼ(t)]
wherein
$$η ( t ) = 0.2 ( 1 - \frac{t}{10000} ) , {h}_{i , j} ( t ) = exp ( - \frac{{d}_{ij}^{2}}{2 {σ}^{2} ( t )} )$$
represents a Gaussian function, dᵢⱼ is a distance between neurons i and j, and σ(t) is a neighborhood radius; and
(f) repeating steps (b) to (e) until the end of the training, so as to obtain two neural network models corresponding to the health status data and the failure status data.

4. The method for evaluating a health status of mechanical equipment according to claim 3, wherein a calculation formula for the rate impact factor in step (7) is as follows:
$${E}_{j} = - {( ln m )}^{1} {\sum }_{i = 1}^{m} {P}_{ij} ln {P}_{ij} , j = , 1 , 2 , … , n$$
$${f}_{j} = 2 - {E}_{j} , j = 1 , 2 , … , n ,$$
wherein fⱼ is an image rate factor,
$${P}_{ij} = \frac{{x}_{ij}}{{\sum }_{i = 1}^{m} {x}_{ij}} ,$$
and xᵢⱼ is a j^{th} element of the i^{th} feature vector in step (5); and
a calculation formula for the health factor is as follows:
$${o}_{r} = F ( min ‖ f Wx {w}_{i} ‖ )$$
$$HI = \frac{{o}_{1}}{{o}_{1} + {o}_{2}} ,$$
wherein HI is a health factor, F(*) represents a function of *, f is a vector composed of nfⱼ, x is a certain feature vector in step (5), and subscript r takes 1 or 2, wherein o₁ is a distance from a feature vector to a health status, and o₂ is a distance from a feature vector to a failure status, which are respectively obtained from a neuron weight wᵢ in two neural network models corresponding to the health status data and the failure status data.

5. The method for evaluating a health status of mechanical equipment according to claim 1, wherein the number of dimensions of the feature vector obtained in step (4) is not greater than 10.

6. The method for evaluating a health status of mechanical equipment according to claim 2, wherein the number of dimensions of the feature vector obtained in step (4) is not greater than 10.

7. The method for evaluating a health status of mechanical equipment according to claim 3, wherein the number of dimensions of the feature vector obtained in step (4) is not greater than 10.

8. The method for evaluating a health status of mechanical equipment according to claim 4, wherein the number of dimensions of the feature vector obtained in step (4) is not greater than 10.
